(19) United States
(12) Patent Application Publication
(10) Pub. No.: US 2022/0217802 A1
(43) Pub. Date: Jul. 7, 2022

(54) SIDELINK INTERFACE STATES FOR CONTROL SIGNALING IN V2X

(71) Applicant: Kyocera Corporation, Kyoto (JP)

(72) Inventors: Henry CHANG, San Diego, CA (US); Amit KALHAN, San Diego, CA (US); Masato FUJISHIRO, Yokohama (JP)

(21) Appl. No.: 17/605,098

(22) PCT Filed: May 1, 2020
(86) PCT No.: PCT/US2020/030925

§ 371 Date: Oct. 20, 2021

Related U.S. Application Data
(60) Provisional application No. 62/842,353, filed on May 2, 2019.

(51) Int. Cl. H04W 76/16; H04W 76/14; H04W 76/20

(52) U.S. Cl. CPC H04W 76/16; H04W 92/18; H04W 76/20; H04W 76/14

(57) ABSTRACT

The methods, devices, and systems discussed herein define sidelink interface (e.g. PCS) states for a unicast connection between two wireless communication devices. A Sidelink-CONNECTED state is a sidelink interface state in which a first wireless communication device establishes and maintains a sidelink channel connection with a second wireless communication device. The first and second wireless communication devices can transmit sidelink unicast transmissions to each other over the sidelink channel connection while operating in the Sidelink-CONNECTED state. A non-Sidelink-CONNECTED state is a sidelink interface state other than the Sidelink-CONNECTED state. The first and second wireless communication devices transition from the Sidelink-CONNECTED state to the non-Sidelink-CONNECTED state upon the occurrence of a triggering event such as a Radio Link Failure.

### CLAIM OF PRIORITY

The present application claims priority to Provisional Application No. 62/842,353, entitled “PC5 STATES FOR CONTROL SIGNALING IN V2X”, filed May 2, 2019, which is assigned to the assignee hereof and hereby expressly incorporated by reference in its entirety.

### FIELD

This invention generally relates to wireless communications and more particularly to vehicle-to-everything (V2X) communications between wireless communication devices.

### BACKGROUND

Unicast transmissions are meant for one-to-one communications, meaning there is one sender and one intended receiver. In some cases, wireless communication devices communicate with each other via unicast transmissions.

### SUMMARY

The methods, devices, and systems discussed herein define sidelink interface (e.g. PC5) states for a unicast connection between two wireless communication devices. A Sidelink-CONNECTED state is a sidelink interface state in which a first wireless communication device establishes and maintains a sidelink channel connection with a second wireless communication device. The first and second wireless communication devices can transmit sidelink unicast transmissions to each other over the sidelink channel connection while operating in the Sidelink-CONNECTED state. A non-Sidelink-CONNECTED state is a sidelink interface state other than the Sidelink-CONNECTED state. The first and second wireless communication devices transition from the Sidelink-CONNECTED state to the non-Sidelink-CONNECTED state upon the occurrence of a triggering event such as a Radio Link Failure.

### BRIEF DESCRIPTION OF THE DRAWINGS

FIG. 1 is a block diagram of an example of a system in which a first wireless communication device transitions between operating in a Sidelink-CONNECTED state, in which the first wireless communication device maintains a sidelink channel connection with another wireless communication device, and a non-Sidelink-CONNECTED state.

FIG. 2 is a block diagram of an example of a wireless communication device shown in FIG. 1.

FIG. 3 is an example of a state diagram of the transitions of a wireless communication device between operating in a Sidelink-CONNECTED state and a non-Sidelink-CONNECTED state.

FIG. 4 is an example of a messaging diagram illustrating two wireless communication devices using synchronized Radio Link Failure (RLF) timers to trigger a transition from operating in a Sidelink-CONNECTED state to a non-Sidelink-CONNECTED state.

FIG. 5 is a flowchart of an example of a method in which a first wireless communication device transitions between operating in a Sidelink-CONNECTED state, in which the first wireless communication device maintains a sidelink channel connection with another wireless communication device, and a non-Sidelink-CONNECTED state.

### DETAILED DESCRIPTION

The examples discussed below are generally directed to vehicle-to-everything (V2X) communication, which is the passing of information from a vehicle to any entity that may affect the vehicle or that the vehicle may affect. For example, V2X is a vehicular communication system that incorporates other, more specific types of communication, including vehicle-to-vehicle (V2V), V2I (vehicle-to-infrastructure), V2N (vehicle-to-network), V2P (vehicle-to-pedestrian), V2D (vehicle-to-device), and V2G (vehicle-to-grid). There are two types of V2X communication technology depending on the underlying technology being used: wireless local area network (WLAN)-based V2X, and cellular-based V2X (C-V2X). Some examples of V2X protocols include Long-Term Evolution (LTE) (Rel-14) V2X Mode 3 and Mode 4 and 5G New Radio (NR) V2X Mode 1 and Mode 2. In some of the examples described herein, the wireless communication devices are vehicle user equipment devices (VUEs) that exchange data (e.g., in the Extended Sensor use case), which is gathered through local sensors, or live video data among vehicles, Road Side Units (RSUs), devices of pedestrians, and V2X application servers.

Sidelink unicast transmissions are supported for V2X over a sidelink (SL) channel such as a PC5 interface, which is an interface used for direct communication between a user equipment device (UE) and another UE. Unicast is meant for one-to-one communications, meaning there is one sender and one intended receiver.

To support a unicast connection between a UE and a base station over a Uu link, the control layer defined by Radio Resource Control (RRC) is utilized, which specifies the UE behavior associated with each of the states for RRC (e.g., RRC_IDLE, RRC_INACTIVE, and RRC_CONNECTED). For example, the RRC_CONNECTED state defines the procedures for Radio Resource Management (RRM), which includes handover procedures and failure handling procedures. The RRC_IDLE and RRC_INACTIVE states define the procedures regarding how the UE selects or reselects cells for “camping” prior to connection establishment or reestablishment.

For Access Stratum (AS)-level link management in unicast, SL Radio Link Monitoring/Radio Link Failure (RLM/RLF) declaration is supported. For Radio Link Control (RLC) Acknowledged Mode (AM) in SL unicast, RLF declaration is triggered by indication from RLC that the maximum number of retransmissions has been reached. The AS-level link status (e.g., failure) should be informed to upper layers.

Unlike the Uu case, there is not a concept of “cells” over the PC5 link. From this perspective, there is also no need for “camping” since there are no cells to “camp” on over the PC5 interface.

In unicast transmissions, the transmitting UE is directly linked to the receiving UE via the PC5 interface (e.g., a sidelink channel). Thus, there is no need to search for another UE to communicate with just because the sidelink channel connection is broken. For example, assume User A is talking with User B over a PC5 link. If the sidelink connection between User A and User B is broken, User A will not just randomly search for and start a conversation with another available user.

In deciding whether PC5-RRC states are needed, it is helpful to understand the purpose for having states, in general, regardless of whether the states are defined within PC5-S (e.g., upper layer signaling) or PC5-RRC (e.g., AS layer signaling). If we initially consider the case when no state is defined, then under normal conditions the unicast connection may be established and released along with capability exchanges in between. However, under poor radio conditions, the unicast connection may be severely disrupted. If we depend solely on PC5-S signaling, and depending on service types, it may take a long time before the upper layer realizes that some problem may have occurred, and latency for services may be severely impacted.

In light of the foregoing, sidelink interface (e.g. PC5) states should be defined for unicast connection. If states can be defined, it would be straightforward to define at least two states, a Sidelink-CONNECTED state and a non-Sidelink-CONNECTED state. Sidelink-CONNECTED is a sidelink interface state in which a first wireless communication device establishes and maintains a sidelink channel connection with a second wireless communication device. The Sidelink-CONNECTED state is a logical connection between a pair of a Source Layer-2 ID and a Destination Layer-2 ID in the AS layer. In particular, Sidelink-CONNECTED state is considered as established only when the sidelink signaling radio bearer (SL-SRB) is established, which means sidelink control signals may be exchanged between the two UEs. A non-Sidelink-CONNECTED state is a sidelink interface state other than the Sidelink-CONNECTED state.

In examples in which the sidelink interface is PC5, then the states would be a PC5-CONNECTED state and a non-PC5-CONNECTED state. Thus, in examples in which the sidelink interface is PC5, the PC5-CONNECTED state is the PC5 state whereby connection establishment has been successfully completed and prior to Connection Release under good PC5 radio link. Therefore, the non-PC5-CONNECTED state would be a state other than the PC5-CONNECTED state. In further examples, the non-PC5-CONNECTED state is a PC5-IDLE state.

The usefulness of defining the operational states may be better explained by the UE (e.g., wireless communication device) behavior under non-PC5-CONNECTED. While the UE is in non-PC5-CONNECTED, unlike the case for RRC_IDLE for the Uu link, there is no need to define where and how the UE should “camp.” Rather, in some examples, non-PC5-CONNECTED is a state whereby the UE determines, in the upper layer, the best available radio interface to establish/reestablish the unicast connection towards a receiving UE.

The reestablishment assumes the ongoing unicast connection was terminated unexpectedly and existing service needs to be restored. In some examples, the procedure for reestablishment is similar to the procedure for establishment, and in these cases, it may be assumed that a UE operating in non-PC5-CONNECTED will discard any SL UE context information exchanged between the UEs while in PC5-CONNECTED. In particular, after transitioning to the non-PC5-CONNECTED state the UE's sidelink Signaling Radio Bearers (SRBs) and sidelink Data Radio Bearers (DRBs) are released. In further examples, the UEs operating in non-PC5-CONNECTED do not perform RLM/RLF procedures.

When a UE transitions to non-PC5-CONNECTED, the UE determines the best available radio interface for establishment/reestablishment of a connection with another UE. In some cases, a unicast connection via PC5, for either LTE or NR, will be the best available radio interface, considering the available channel(s). In other cases, the Uu link, which is the wireless communication link between the UE and a base station, may be the best option. Stated differently, the UE may determine that a communication link via a base station may be a better radio interface to another UE than any available sidelink channels.

Although the different examples set forth herein may be described separately, any of the features of any of the examples may be added to, omitted from, or combined with any other example. Similarly, any of the features of any of the examples may be performed in parallel or performed in a different manner/order than that described or shown herein.

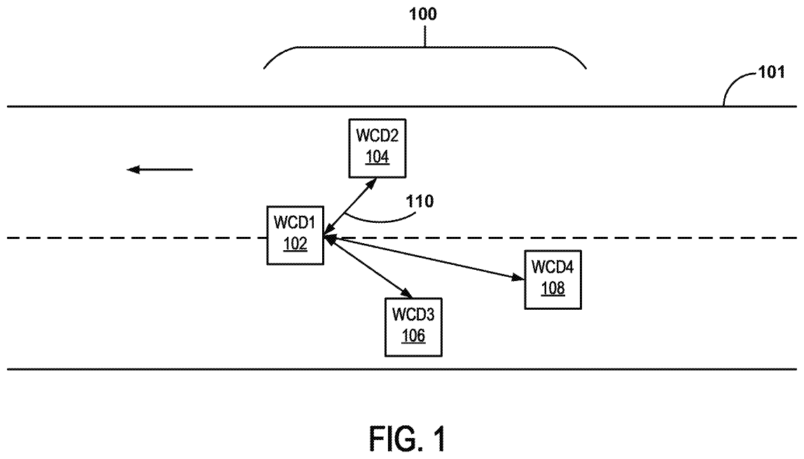

FIG. 1 is a block diagram of an example of a system in which a first wireless communication device transitions between operating in a Sidelink-CONNECTED state, in which the first wireless communication device establishes and maintains a sidelink channel connection with another wireless communication device, and a non-Sidelink-CONNECTED state. For the example of FIG. 1, a group 100 of wireless communication devices is located on roadway 101. The group 100 includes first wireless communication device, WCD1, 102, second wireless communication device, WCD2, 104, third wireless communication device, WCD3, 106, and fourth wireless communication device, WCD4, 108. In other examples, the group 100 may have a different number of wireless communication devices than that shown in FIG. 1.

The group 100 is wirelessly connected to a radio access network (not shown) via one or more base stations (not shown), which provide various wireless services to one or more of the wireless communication devices that are part of the group 100. For the example shown in FIG. 1, the group 100 operates in accordance with at least one revision of the 3rd Generation Partnership Project 5G New Radio (3GPP 5G NR) communication specification. In other examples, the group 100 may operate in accordance with other communication specifications.

In the example of FIG. 1, wireless communication devices 102, 104, 106, 108 are each integrated into a vehicle as an onboard unit (OBU). In other examples, wireless communication devices 102, 104, 106, 108 may simply be user equipment (UE) devices that are located within a vehicle. Some examples of user equipment devices include: a mobile phone, a transceiver modem, a personal digital assistant (PDA), or a tablet, for example. Any of the foregoing devices may also be referenced herein as vehicle UEs (VUEs). Each wireless communication device 102, 104, 106, 108 that is connected to group 100 is considered to be a member of group 100.

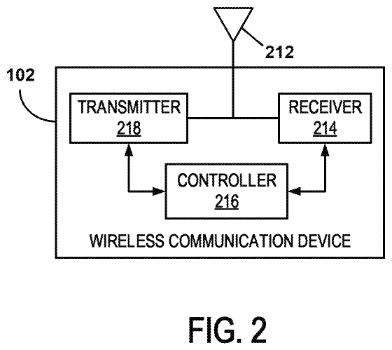

As shown in FIG. 2, wireless communication device 102 comprises controller 216, transmitter 218, and receiver 214, as well as other electronics, hardware, and code. Although FIG. 2 specifically depicts the circuitry and configuration of wireless communication device 102, the same wireless communication device circuitry and configuration is utilized for wireless communication devices 104, 106, 108 in group 100. In other examples, any of the wireless communication devices may have circuitry and/or a configuration that differs from that of wireless communication device 102 shown in FIG. 2.

Wireless communication device 102 is any fixed, mobile, or portable equipment that performs the functions described herein. The various functions and operations of the blocks described with reference to wireless communication device 102 may be implemented in any number of devices, circuits, or elements. Two or more of the functional blocks may be integrated in a single device, and the functions described as performed in any single device may be implemented over several devices.

Controller 216 includes any combination of hardware, software, and/or firmware for executing the functions described herein as well as facilitating the overall functionality of a wireless communication device. An example of a suitable controller 216 includes code running on a microprocessor or processor arrangement connected to memory. Transmitter 218 includes electronics configured to transmit wireless signals. In some situations, the transmitter 218 may include multiple transmitters. Receiver 214 includes electronics configured to receive wireless signals. In some situations, receiver 214 may include multiple receivers. Receiver 214 and transmitter 218 receive and transmit signals, respectively, through antenna 212. Antenna 212 may include separate transmit and receive antennas. In some circumstances, antenna 212 may include multiple transmit and receive antennas.

Transmitter 218 and receiver 214 in the example of FIG. 2 perform radio frequency (RF) processing including modulation and demodulation. Receiver 214, therefore, may include components such as low noise amplifiers (LNAs) and filters. Transmitter 218 may include filters and amplifiers. Other components may include isolators, matching circuits, and other RF components. These components in combination or cooperation with other components perform the wireless communication device functions. The required components may depend on the particular functionality required by the wireless communication device.

Transmitter 218 includes a modulator (not shown), and receiver 214 includes a demodulator (not shown). The modulator can apply any one of a plurality of modulation orders to modulate the signals to be transmitted over sidelink channel connection 110. In the example of FIG. 1, the signals transmitted over sidelink channel connection 110 are unicast transmissions. The demodulator demodulates signals received over sidelink channel connection 110, in accordance with one of a plurality of modulation orders.

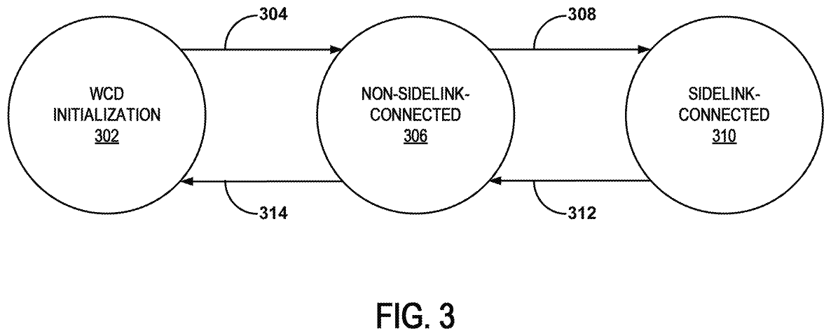

FIG. 3 is an example of a state diagram showing the transitions of a wireless communication device between operating in a Sidelink-CONNECTED state and a non-Sidelink-CONNECTED state. In the examples described herein, it is generally understood that the Sidelink-CONNECTED state and the non-Sidelink-CONNECTED states are applicable if the UE intends to establish unicast connection with another UE. However, in alternative examples, the Sidelink-CONNECTED state and the non-Sidelink-CONNECTED state, or variations thereof, may be used in conjunction with other types of connections.

In FIG. 3, Wireless Communication Device Initialization (WCD Initialization) state 302 represents the state in which wireless communication device 102 is powered on. When wireless communication device 102 starts the application 304 that will enable wireless communication device 102 to establish a sidelink channel (e.g., PC5) connection with another wireless communication device, controller 216 of wireless communication device 102 operates wireless communication device 102 in the non-Sidelink-CONNECTED state 306. In the non-Sidelink-CONNECTED state 306, wireless communication device 102 determines, via controller 216, the best available radio interface for the connection with target wireless communication device 104.

In some examples, the best available radio interface is based, at least partially, on which radio interface has the highest Reference Signal Receive Power (RSRP) level. In further examples, the best available radio interface is selected from the following: a Uu interface, and a PC5 interface that complies with at least one of the following specifications: 3rd Generation Partnership Project (3GPP) Long-Term Evolution (LTE), and 3GPP 5G New Radio (NR). In the example shown in FIG. 3, wireless communication device 102 informs its upper layer of the determined best available radio interface. In other examples, any suitable radio interface (e.g., that meets a minimum quality threshold) may be utilized, even if it is not the best. In alternative examples, the upper layer is not informed of the selected radio interface.

When wireless communication device 102 transmits, via its transmitter 218 and antenna 212, an establishment request 308 that is accepted by wireless communication device 104, controller 216 of wireless communication device 102 operates wireless communication device 102 in the Sidelink-CONNECTED state 310. In the Sidelink-CONNECTED state 310, wireless communication device 102 maintains sidelink channel connection 110 with wireless communication device 104. While in the Sidelink-CONNECTED state 310, wireless communication device 102 transmits, via its transmitter 218 and antenna 212, sidelink unicast transmissions over the sidelink channel connection 110 to wireless communication device 104. Likewise, while in the Sidelink-CONNECTED state 310, wireless communication device 102 receives, via its antenna 212 and receiver 214, sidelink unicast transmissions over the sidelink channel connection 110 from wireless communication device 104.

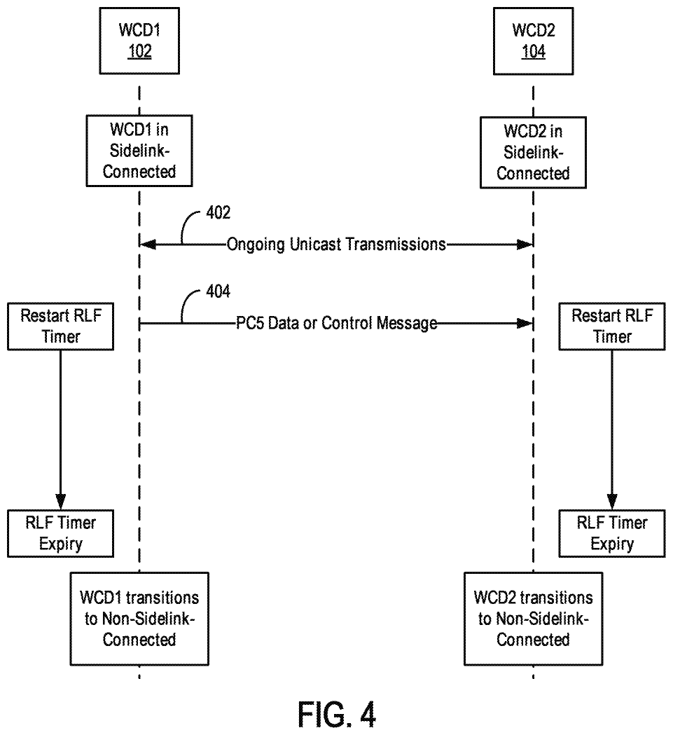

Controller 216 of wireless communication device 102 is further configured to transition wireless communication device 102 from the Sidelink-CONNECTED state 310 to the non-Sidelink-CONNECTED state 306 upon the occurrence of a triggering event 312. In some examples, wireless communication device 102 performs RLM/RLF procedures with regards to the ongoing status/quality of sidelink channel connection 110 while operating in the Sidelink-CONNECTED state 310. In the example of FIG. 3, the triggering event 312, which triggers transition of wireless communication device 102 from the Sidelink-CONNECTED state 310 to the non-Sidelink-CONNECTED state 306, is at least one of the following: a decrease in a quality level of the sidelink channel connection 110 between wireless communication device 102 and wireless communication device 104, as measured during a Radio Link Monitoring (RLM) procedure; and a determination that a Radio Link Failure (RLF) of the sidelink channel connection 110 between wireless communication device 102 and wireless communication device 104 has occurred. In some examples, at least one of the RLM procedure and the RLF determination are based on one or more received Physical Sidelink Control Channel (PSCCH) transmissions. Alternatively, the triggering event 312 could be a normal release of the sidelink channel connection 110 between wireless communication device 102 and wireless communication device 104. A normal release would involve the upper layer's instruction to the AS layer to release the connection. In other examples, the triggering event 312 may include expiry of an RLF timer, as described below in connection with FIG. 4, or an RLF determination based on reaching the maximum number of RLC retransmissions for the case of RLC AM configuration. In further examples, any other suitable triggering event may be used.

If wireless communication device 102 transitions from the Sidelink-CONNECTED state 310 to the non-Sidelink-CONNECTED state 306 because the sidelink channel connection 110 between wireless communication device 102 and wireless communication device 104 was terminated unexpectedly and needs to be reestablished, controller 216 of wireless communication device 102 discards any SL UE context information exchanged between wireless communication device 102 and wireless communication device 104 while operating in the Sidelink-CONNECTED state 310, in the example shown in FIG. 3. In alternative examples, wireless communication device 102 maintains the SL UE context information and utilizes it to facilitate reestablishment of the sidelink channel connection 110 with wireless communication device 104.

Wireless communication device 102 also determines the best available radio interface, as described above, for the reestablishment of the sidelink channel connection 110 with wireless communication device 104 and informs the upper layer of the determined best available radio interface. In other examples, any suitable radio interface may be selected, and the upper layer may not be informed of the selected radio interface.

If wireless communication device 102 no longer wishes to utilize a sidelink channel (e.g., PC5) connection with another wireless communication device, wireless communication device 102 terminates the application 314 that enables wireless communication device 102 to operate in the Sidelink-CONNECTED state 310.

The operational states described herein are defined within the PC5-S signaling protocol stack or the PC5-Radio Resource Control (PC5-RRC) Access Stratum (AS) layer. Considering the changes in radio condition, even if the state is defined within PC5-S, some assistance from the AS layer is needed for the upper layer to know the condition of the radio link. Regardless if the states are defined within PC5-S or PC5-RRC, the upper layer should know the UE's current state. In some examples, it would be straightforward to define the state as part of PC5-RRC since RLM/RLF is typically defined in the AS layer. Although no reference signal is dedicated just for SL RLM, a SL reference signal (RS) introduced for other purpose(s) is reused for SL RLM/RLF, in some examples.

In other examples, wireless communication device 102 is allowed to periodically transmit Physical Sidelink Control Channel (PSCCH)-only signals towards wireless communication device 104, which uses the received PSCCH-only signals for RLM/RLF. As a response to receiving a PSCCH-only signal from wireless communication device 102, wireless communication device 104 transmits a PSCCH-only transmission to wireless communication device 102 within a specified time period. In some examples, wireless communication device 102 uses the PSCCH-only transmission received from wireless communication device 104 for RLM/RLF.

Both wireless communication device 102 and wireless communication device 104 should be able to determine when RLF should be declared. More specifically, wireless communication device 102 should know whether wireless communication device 104 has experienced RLF and vice versa. In some examples, wireless communication devices 102 can determine when to declare RLF based, at least partially, on a lack of Hybrid Automatic Repeat Request (HARQ) feedback (e.g., HARQ discontinuous transmission (DTX)) or Channel State Information Reference Signal (CSI-RS) feedback received from wireless communication device 104. In particular, in some situations the wireless communication device 104 cannot even decode the Sidelink Control Information (SCI), which is contained within the PSCCH, sent from wireless communication device 102.

FIG. 4 illustrates an alternative example for determining when to declare RLF and when wireless communication device 102 and wireless communication device 104 should transition to the non-Sidelink-CONNECTED state 306. More specifically, FIG. 4 is an example of a messaging diagram illustrating two wireless communication devices using synchronized Radio Link Failure (RLF) timers to trigger a transition from operating in a Sidelink-CONNECTED state to a non-Sidelink-CONNECTED state. Initially, wireless communication device 102 and wireless communication device 104 are both operating in a Sidelink-CONNECTED state 310 and are transmitting unicast transmissions 402 with each other via the sidelink channel connection 110.

In the example shown in FIG. 4, wireless communication device 104 starts, via its controller 216, an RLF timer upon receipt of a data or control message (e.g., PC5 data or control message) 404 sent from wireless communication device 102 via sidelink channel connection 110. Similarly, wireless communication device 102 starts, via its controller 216, an RLF timer upon transmission of the data or control message (e.g., PC5 data or control message) 404 to wireless communication device 104. Since both wireless communication device 102 and wireless communication device 104 start their respective RLF timers at approximately the same time, the RLF timers are considered to be synchronized.

If another unicast message, including ARQ and HARQ feedbacks, is sent between wireless communication device 102 and wireless communication device 104, the RLF timers are restarted. Upon expiry of the synchronized RLF timers, both wireless communication device 102 and wireless communication device 104 transition to the non-Sidelink-CONNECTED state 306. In some cases, the AS layer will inform the upper layer of the RLF, then the upper layer will instruct the AS layer to transition to the non-Sidelink-CONNECTED state 306.

Thus, upon expiry of either or both RLF timers, RLF is declared. One example of this would be if wireless communication device 102 transmitted a message to wireless communication device 104 and started the RLF timer for wireless communication device 102. In the event that wireless communication device 104 does not receive the message and does not respond by sending either a feedback message or another data/control message to wireless communication device 102, wireless communication device 102 will declare an RLF upon expiry of the RLF timer of wireless communication device 102.

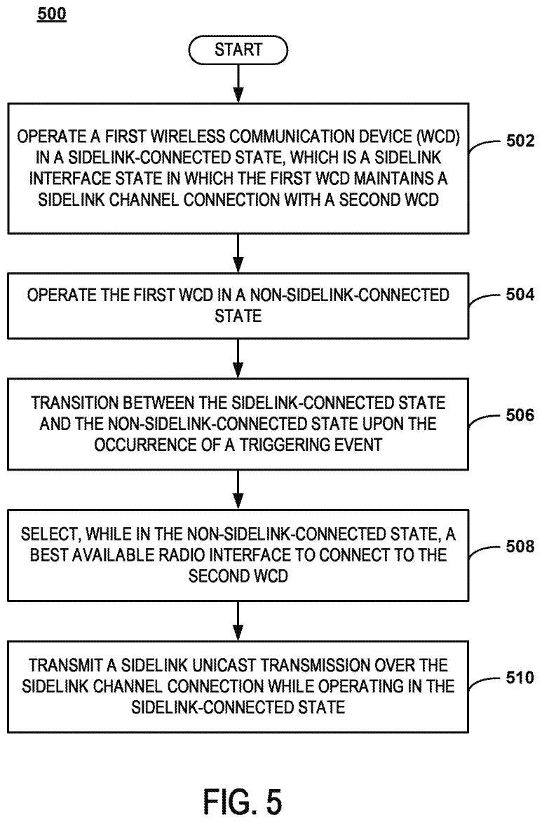

FIG. 5 is a flowchart of an example of a method in which a first wireless communication device transitions between operating in a Sidelink-CONNECTED state, in which the first wireless communication device establishes and maintains a sidelink channel connection with another wireless communication device, and a non-Sidelink-CONNECTED state. The method 500 begins at step 502 with operating a first wireless communication device 102 in a Sidelink-CONNECTED state 310, which is a sidelink interface state in which the first wireless communication device 102 maintains a sidelink channel connection 110 with a second wireless communication device 104. At step 504, the first wireless communication device 102 is operated in a non-Sidelink-CONNECTED state 306. At step 506, the first wireless communication device 102 transitions between the Sidelink-CONNECTED state 310 and the non-Sidelink-CONNECTED state 306 upon the occurrence of a triggering event 312. At step 508, first wireless communication device 102 selects, while in the non-Sidelink-CONNECTED state 306, a best available radio interface to connect to the second wireless communication device 104. At step 510, first wireless communication device 102 transmits a sidelink unicast transmission over the sidelink channel connection 110 while operating in the Sidelink-CONNECTED state 310. In other examples, one or more of the steps of method 500 may be omitted, combined, performed in parallel, or performed in a different order than that described herein or shown in FIG. 5. In still further examples, additional steps may be added to method 500 that are not explicitly described in connection with the example shown in FIG. 5.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A first wireless communication device comprising:
a controller configured to:
operate in a Sidelink-CONNECTED state, which is a sidelink interface state in which the first wireless communication device maintains a sidelink channel connection with a second wireless communication device,
operate in a non-Sidelink-CONNECTED state, which is a sidelink interface state other than the Sidelink-CONNECTED state, and
transition between the Sidelink-CONNECTED state and the non-Sidelink-CONNECTED state upon the occurrence of a triggering event; and
a transmitter configured to transmit a sidelink unicast transmission over the sidelink channel connection while operating in the Sidelink-CONNECTED state.

2. The first wireless communication device of claim 1, wherein the Sidelink-CONNECTED state is a PC5-CONNECTED state and the non-Sidelink-CONNECTED state is a PC5-IDLE state.

3. The first wireless communication device of claim 2, wherein the PC5-IDLE state and the PC5-CONNECTED state are defined within a PC5-S signaling protocol stack.

4. The first wireless communication device of claim 2, wherein the PC5-IDLE state and the PC5-CONNECTED state are defined within a PC5-Radio Resource Control (PC5-RRC) Access Stratum layer.

5. The first wireless communication device of claim 1, wherein the controller is further configured to select, while in the non-Sidelink-CONNECTED state, a best available radio interface to connect to the second wireless communication device.

6. The first wireless communication device of claim 5, wherein the best available radio interface is based, at least partially, on which radio interface has the highest Reference Signal Receive Power (RSRP) level.

7. The first wireless communication device of claim 5, wherein the best available radio interface is selected from the following: a Uu interface, and a PC5 interface.

8. The first wireless communication device of claim 7, wherein the PC5 interface complies with at least one of the following specifications: 3rd Generation Partnership Project (3GPP) Long-Term Evolution (LTE), and 3GPP 5G New Radio (NR).

9. The first wireless communication device of claim 1, wherein the triggering event is at least one of the following: a decrease in a quality level of the sidelink channel connection between the first wireless communication device and the second wireless communication device, as measured during a Radio Link Monitoring (RLM) procedure; and a determination that a Radio Link Failure (RLF) of the sidelink channel connection between the first wireless communication device and the second wireless communication device has occurred.

10. The first wireless communication device of claim 9, wherein at least one of the RLM procedure and the RLF determination are based on one or more received Physical Sidelink Control Channel (PSCCH) transmissions.

11. The first wireless communication device of claim 9, wherein the controller is further configured to start an RLF timer upon transmission or reception of a first PC5 data or control message.

12. The first wireless communication device of claim 11, wherein the controller is further configured to restart the RLF timer when a second PC5 data or control message is transmitted or received.

13. The first wireless communication device of claim 11, wherein the PC5 data or control message is one of the following: an Automatic Repeat Request (ARQ) feedback message, or a Hybrid ARQ (HARQ) feedback message.

14. The first wireless communication device of claim 13 wherein the HARQ feedback message utilizes a HARQ DTX.

15. The first wireless communication device of claim 11, wherein the triggering event is expiry of the RLF timer.

16. A method comprising:
operating a first wireless communication device in a Sidelink-CONNECTED state, which is a sidelink interface state in which the first wireless communication device maintains a sidelink channel connection with a second wireless communication device;
operating the first wireless communication device in a non-Sidelink-CONNECTED state, which is a sidelink interface state other than the Sidelink-CONNECTED state;
transitioning between the Sidelink-CONNECTED state and the non-Sidelink-CONNECTED state upon the occurrence of a triggering event; and
transmitting a sidelink unicast transmission over the sidelink channel connection while operating in the Sidelink-CONNECTED state.

17. The method of claim 16, wherein the Sidelink-CONNECTED state is a PC5-CONNECTED state and the non-Sidelink-CONNECTED state is a PC5-IDLE state.

18. The method of claim 17, wherein the PC5-IDLE state and the PC5-CONNECTED state are defined within a PC5-S signaling protocol stack.

19. The method of claim 17, wherein the PC5-IDLE state and the PC5-CONNECTED state are defined within a PC5-Radio Resource Control (PC5-RRC) Access Stratum layer.

20. The method of claim 16, wherein the controller is further configured to select, while in the non-Sidelink-CONNECTED state, a best available radio interface to connect to the second wireless communication device.

21. The method of claim 20, wherein the best available radio interface is based, at least partially, on which radio interface has the highest Reference Signal Receive Power (RSRP) level.

22. The method of claim 20, wherein the best available radio interface is selected from the following: a Uu interface, and a PC5 interface.

23. The method of claim 22, wherein the PC5 interface complies with at least one of the following specifications: 3rd Generation Partnership Project (3GPP) Long-Term Evolution (LTE), and 3GPP 5G New Radio (NR).

24. The method of claim 16, wherein the triggering event is at least one of the following: a decrease in a quality level of the sidelink channel connection between the first wireless communication device and the second wireless communication device, as measured during a Radio Link Monitoring (RLM) procedure; and a determination that a Radio Link Failure (RLF) of the sidelink channel connection between the first wireless communication device and the second wireless communication device has occurred.

25. The method of claim 24, wherein at least one of the RLM procedure and the RLF determination are based on one or more received Physical Sidelink Control Channel (PSCCH) transmissions.

26. The method of claim 24, wherein the controller is further configured to start an RLF timer upon transmission or reception of a first PC5 data or control message.

27. The method of claim 26, wherein the controller is further configured to restart the RLF timer when a second PC5 data or control message is transmitted or received.

28. The method of claim 26, wherein the PC5 data or control message is one of the following: an Automatic Repeat Request (ARQ) feedback message, or a Hybrid ARQ (HARQ) feedback message.

29. The method of claim 28, wherein the HARQ feedback message utilizes a HARQ DTX.

30. The method of claim 26, wherein the triggering event is expiry of the RLF timer.
